(19) United States
(12) Patent Application Publication
(10) Pub. No.: US 2016/0040636 A1
(43) Pub. Date: Feb. 11, 2016

(54) AIR SUPPLY SYSTEM

(71) Applicants: MAHLE INTERNATIONAL GMBH, Stuttgart (DE); MAHLE BEHR GMBH & CO. KG, Stuttgart (DE)

(72) Inventors: Veit Bruggesser, Hildrezhausen (DE); Andreas Eilemann, Erdmannhausen (DE); Uwe Grass, Stuttgart (DE); Rolf Mueller, Steinheim/Murr (DE); Hubert Pomin, Sindelfingen (DE); Christian Saumweber, Stuttgart (DE); Juergen Stehlig, Neckartenzlingen (DE)

(73) Assignees: MAHLE INTERNATIONAL GMBH, Stuttgart (DE); MAHLE BEHR GMBH & CO. KG, Stuttgart (DE)

(21) Appl. No.: 14/780,109

(22) PCT Filed: Mar. 25, 2014
(86) PCT No.: PCT/EP2014/055939

§ 371 Date: Sep. 25, 2015

(30) Foreign Application Priority Data
Mar. 26, 2013 (DE) 10 2013 205 316.9

(51) Int. Cl. F02M 35/10; F02B 39/00; F02B 75/18; F02B 33/40

(52) U.S. Cl. CPC F02M 35/10163; F02B 33/40; F02B 39/00; F02B 75/18; F02M 35/10144; F02M 35/10268

(57) ABSTRACT

An air supply system for supplying fresh air to at least one combustion chamber of an internal combustion engine may include a housing having a fresh air path and a lateral introduction opening. A charge-air cooler may be instertable into the housing via the introduction opening along an introduction direction. The charge-air cooler may be arranged in the housing and the fresh air path may extend through the charge air cooler. The charge air cooler may include an outer end region closing the introduction opening. The outer end region of the charge-air cooler may be secured to the housing.

### CROSS-REFERENCE TO RELATED APPLICATIONS

This application claims priority to German Patent Application No. 10 2013 205 316.9, filed Mar. 26, 2013, and International Patent Application No. PCT/EP2014/055939, filed Mar. 25, 2014, all of which are hereby incorporated by reference in their entirety.

### TECHNICAL FIELD

The present invention relates to an air supply system for supplying the combustion chambers of a supercharged internal combustion engine with fresh air, in particular in a motor vehicle.

### BACKGROUND

Such an air supply system usually comprises a housing, through which a fresh air path runs. In a supercharged internal combustion engine, it is usual to cool the supercharged fresh air, i.e. the charge air, before entry into the combustion chambers. For this, such an air supply system can be equipped with a charge-air cooler which is able to be flowed through by the fresh air and which is arranged in the fresh air path. The charge-air cooler can be inserted here in various ways into the housing of the air supply system. An introduction solution is basically conceivable, in which the charge-air cooler is introduced or respectively inserted into the housing laterally, i.e. transversely to the flow direction. For this, the housing can have a lateral introduction opening, through which the charge-air cooler is able to be inserted laterally into the housing, transversely to the fresh air path. In such an introduction solution, the introduction opening can be closed for example by an outer end region of the charge-air cooler, which has, at the same time, connections for the supplying and discharging of a coolant. In order to realize a sufficient fixing of the charge-air cooler on the housing in the region of the introduction opening and in order to achieve a sufficient seal between charge-air cooler and housing in the region of the introduction opening, a comparatively great effort can be expended.

### SUMMARY

The present invention is concerned with the problem of indicating for an air supply system of the type named in the introduction an improved embodiment, which is distinguished in particular by being able to be produced economically.

This problem is solved according to the invention by the subject of the independent claim(s). Advantageous embodiments are the subject of the dependent claims.

The invention is based on the general idea of configuring the outer end region of the charge-air cooler and the housing in the region of the introduction opening so that the charge-air cooler can be locked directly with the housing in the region of the introduction opening. By means of such a locking, the charge-air cooler can be assembled in a particularly simple manner on the housing. In particular, such a locking can serve as an exclusive fastening of the charge-air cooler on the housing in the region of the introduction opening, so that additional fastening means can be dispensed with.

According to an advantageous embodiment, the charge-air cooler can have detent elements, which cooperate with counter-detent elements complementary thereto, which the housing has. The charge-air cooler and housing therefore have detent means coordinated with one another, in order to realize the locking between charge-air cooler and housing.

According to an advantageous further development, the detent elements can be formed integrally on the charge-air cooler. Hereby, a particularly economical realization of the locking is produced, because separate detent elements which must be mounted on the charge-air cooler, can be dispensed with.

In another further development, the counter-detent elements can be formed integrally on the housing. This measure also leads to an economical realization of the locking, because in particular separate counter-detent elements can be dispensed with, which would have to be mounted on the housing. In particular, the housing can be produced here from a plastic, preferably by means of injection moulding technique. The counter-detent elements can therefore be injection-moulded in an integrated manner with the housing.

In another advantageous further development, the detent elements can be formed by detent hooks, whilst the counter-detent elements are formed by detent contours, with which the detent hooks are in engagement. Such detent contours can form an undercut here, i.e. an engaging in or engaging over the respective detent hook on an engagement zone facing away from the introduction direction. By the engagement between detent hook and detent contour, a form-fitting connection is produced, which is able to be subjected to tensile load contrary to the introduction direction. The detent hooks can be designed in a spring-elastic manner expediently transversely to the introduction direction, whereby the assembly or respectively the locking during mounting is simplified.

According to an alternative embodiment, the detent elements can be formed by detent contours, whilst the counter-detent elements are formed by detent hooks which are in engagement with the detent contours. Here, also, the same advantages are again produced, such as in particular the formation of undercuts and the formation of form-fitting connections which are able to be subjected to tensile load. Here, also, the detent hooks can again be configured in a spring-elastic manner transversely to the introduction direction.

In another advantageous embodiment, the outer end region can have at least one circumferential contact region, which lies opposite an abutment region running around the introduction opening, parallel to the introduction direction or respectively in the introduction direction. Hereby, a defined cooperation between housing and charge-air cooler is made possible.

According to a further development, the respective contact region can lie directly against the associated abutment region. By the contacting between contact region and abutment region, a predetermined relative position results between the charge-air cooler and the housing, whereby a reproducible positioning of the charge-air cooler in the housing can be achieved.

In another advantageous embodiment, at least one seal running around the introduction opening can be arranged between the housing and the outer end region. By means of such a seal, an exit of air from the housing through the introduction opening can be prevented.

According to an advantageous embodiment, the respective contact region can be spaced apart from the associated abutment region in the introduction direction, so that a gap is formed in the introduction direction between the respective contact region and the associated abutment region, which is bridged by the respective seal, whereby an elastic support is produced between the housing and the charge-air cooler. Such an elastic support can bring about a vibration isolation between the housing and the charge-air cooler, in order to reduce the mechanical stress of the charge-air cooler. By means of the gap, the assembly is also simplified. In addition, thermally caused relative movements between charge-air cooler and housing can be received elastically by the respective seal, which reduces thermally caused stresses. Finally, the respective seal can also better compensate manufacturing tolerances.

In a simple further development, provision can be made that the charge-air cooler is supported elastically on the housing by means of such a seal only in the introduction direction. Contrary to the introduction direction, a direct contacting can then be present between components of the charge-air cooler and components of the housing. For example, the locking can bring about a direct contact between a detent contour of the charge-air cooler and spring-elastic detent elements of the housing. In any case, also in this simple type of construction, a certain vibration isolation can be achieved.

According to a preferred alternative further development, on the other hand, provision can be made that on the one hand the charge-air cooler is supported elastically on the housing by means of a first such seal in the introduction direction, and that on the other hand the charge-air cooler is supported elastically on the housing by means of a second such seal contrary to the introduction direction. Hereby, a particularly efficient vibration isolation is achieved.

In another further development, the first seal can be arranged in a first pair of contact region and abutment region, whilst the second seal is arranged in a second pair of contact region and abutment region spaced apart from the first pair, parallel to the introduction direction. Hereby, the assembly is simplified. In addition, provision can optionally be made to arrange the first seal and the second seal concentrically in one another with respect to the introduction direction.

A further development is particularly expedient, in which the respective seal in the region of the respective contact region is inserted into a circumferential sealing groove with respect to the introduction opening, which sealing groove is formed in the respective contact region and/or in the respective abutment region. The arrangement of the respective seal in the contact region is particularly expedient, because both the contact region and also the abutment region run around the introduction opening, so that in this region an efficient axial seal, i.e. a seal acting parallel to the introduction direction, is able to be realized.

Further important features and advantages of the invention will emerge from the subclaims, from the drawings and from the associated figure description with the aid of the drawings.

It shall be understood that the features mentioned above and to be further explained below are able to be used not only in the respectively indicated combination, but also in other combinations or in isolation, without departing from the scope of the present invention.

### BRIEF DESCRIPTION OF THE DRAWINGS

Preferred example embodiments of the invention are illustrated in the drawings and are explained in further detail in the following description, wherein the same reference numbers refer to identical or similar of functionally identical components.

There are shown, respectively diagrammatically,

FIG. 1 a greatly simplified schematic illustration, in the manner of a circuit diagram, of an internal combustion engine with an air supply system, which contains a charge-air cooler,

FIG. 2 a greatly simplified longitudinal section of the air supply system in the region of an introduction opening for introducing the charge-air cooler into the air supply system,

FIG. 3 a sectional view as in FIG. 2, but in another embodiment,

FIG. 4 a variant of the embodiment shown in FIG. 2,

FIG. 5 a variant of the embodiment shown in FIG. 3.

### DETAILED DESCRIPTION

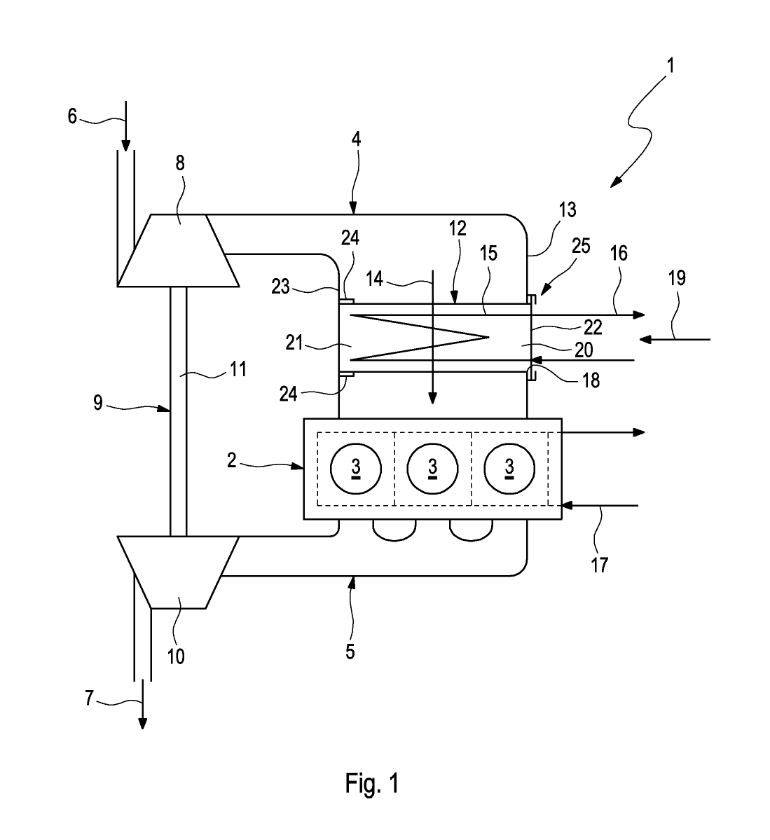

According to FIG. 1, an internal combustion engine 1 comprises an engine block 2, in which several combustion chambers 3 are arranged. The combustion chambers are formed here by cylinders, in which pistons are arranged such that their stroke is adjustable. The internal combustion engine 1 further comprises an air supply system 4 for the supplying of fresh air to the combustion chambers 3, and an exhaust gas system 5 for the discharging of exhaust gas from the combustion chambers 3. A corresponding fresh air flow 6 is indicated in FIG. 1 by an arrow. A corresponding exhaust gas flow 7 is indicated in FIG. 1 by an arrow. The internal combustion engine 1 is configured here as a supercharged internal combustion engine 1. For this, the internal combustion engine 1 is equipped with a corresponding charging device, which is formed here by a compressor 8 of an exhaust gas turbocharger 9. For this, the compressor 8 is arranged in the air supply system 4. The compressor 8, or respectively a compressor wheel not illustrated in further detail here, is driven in the case of the exhaust gas turbocharger 9 by means of a turbine 10 or respectively with a turbine wheel which is not illustrated here, for which the compressor 8 and the turbine 10 are in drive connection with a shared shaft 11. The turbine 10 is arranged in the exhaust gas system 5.

It is clear that the air supply system 4 can contain further components, such as e.g. a throttle arrangement and a fresh air filter. In addition, it is clear that the exhaust gas system 5 can also contain further components, such as e.g. a particle filter, a catalytic converter and a sound absorber.

The air which is compressed by means of the compressor 8 is, at the same time, heated by its compressing. In order to be able to cool the charge-air again, a charge-air cooler 12 is arranged in the air supply system 4, and namely downstream of the compressor 8. To accommodate the charge-air cooler 12, the air supply system 4 has a housing 13, through which a fresh air path 14 runs, which is symbolised in FIG. 1 by an arrow. The charge-air cooler 12 is now arranged in the housing 13 such that the fresh air path 14 runs through the charge-air cooler 12. Accordingly, the charge-air cooler 12 is able to be flowed through by the fresh air. The charge-air cooler 12 additionally receives a coolant path 15, which is coupled in a suitable manner with the fresh air path 14 in a heat-transmitting manner but separated from the media. The coolant path 15 can be connected to a charge-air cooling circuit 16. This charge-air cooling circuit 16 can be coupled in a heat-transmitting manner with an engine cooling circuit 17, which serves for cooling the engine block 2. The charge-air cooling circuit 16 and the engine cooling circuit 17 can also be separate cooling circuits.

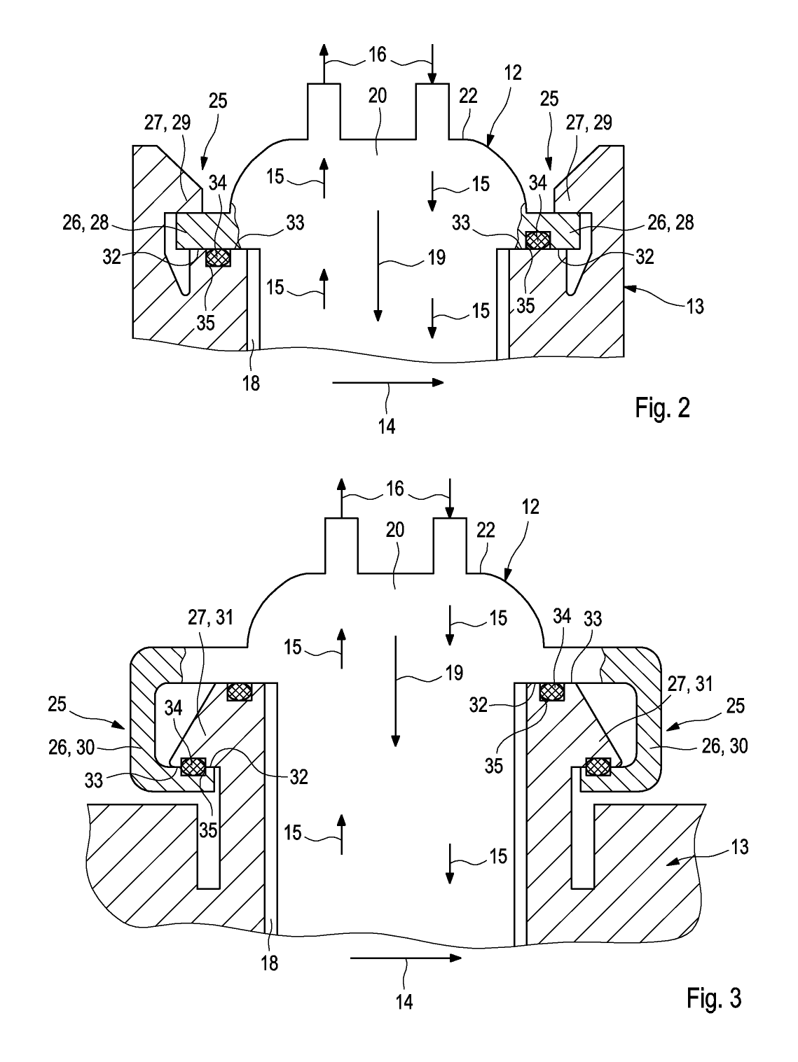

According to FIGS. 1 to 5, the housing 13 comprises an introduction opening 18, through which the charge-air cooler 12 is inserted laterally into the housing 13 in an introduction direction 19 or insertion direction 19. The introduction direction 19 is oriented here transversely to the fresh air path 14. In FIGS. 2 to 5, the housing 13 is illustrated only rudimentarily, namely only in the region of the introduction opening 18.

According to FIG. 1, the charge-air cooler 12 has an outer end region 20 and an inner end region 21, which with respect to the introduction direction 19 are arranged distally to one another or respectively facing away from one another. On inserting of the charge-air cooler 12 into the housing 13 the inner end region 21 leads and in the inserted state is situated completely within the housing 13. In contrast thereto, the outer end region 20 in the inserted state of the charge-air cooler 12 forms a closure for the introduction opening 18. At least one face side 22 of the charge-air cooler 12, facing away from the inner end region 21 or respectively from the fresh air path 14, which face side is situated on the outer end region 20, remains outside the housing 13.

As can be seen further from FIG. 1, the housing 13 can have positioning elements 24 on a wall 23 lying opposite the introduction opening 18. In the inserted state of the charge-air cooler 12, these cooperate with the inner end region 21 for the positioning of the charge-air cooler 12 in the housing 13.

As can be seen in particular from FIGS. 2 to 5, a locking arrangement 25 is provided for fixing the charge-air cooler 12 on the housing 13 in the region of the introduction opening 18, so that the outer end region 20 of the charge-air cooler 12 is locked in the region of the introduction opening 18 with the housing 13. For this, the charge-air cooler 12 has at least one detent element 26, whilst the housing 13 has at least one counter-detent element 27, which is configured in a complementary manner to the respective detent element 26 and cooperates therewith.

Expediently, the respective detent element 26 is formed integrally on the charge-air cooler 12. For example, the charge-air cooler 12 is assembled in a conventional manner from several metal sheets. The respective detent element 26 can then be formed integrally by corresponding shaping on a metal sheet associated with the outer end region 20. Expediently, the respective counter-detent element 27 is also formed integrally on the housing 13. The housing 13 is preferably a plastic component, which is produced by means of injection moulding technique. Consequently, the respective counter-detent element 27 can then be formed integrally on the housing 13 particularly simply during injection moulding.

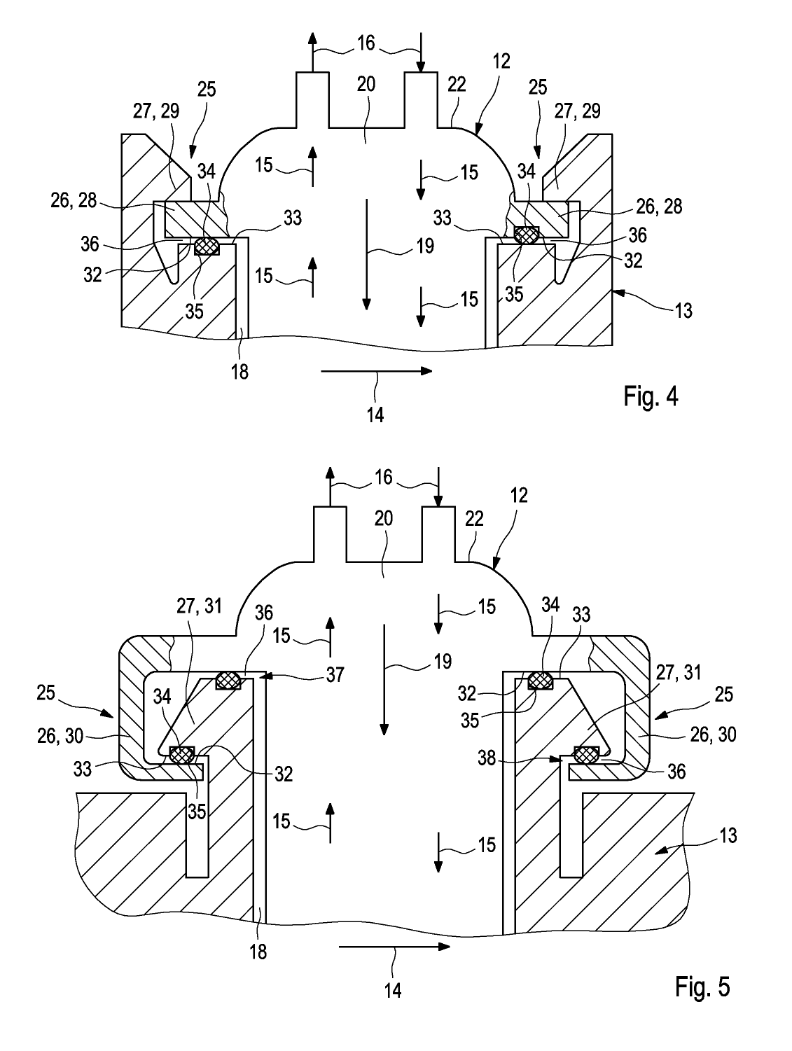

In the embodiments shown in FIGS. 2 and 4, the respective detent element 26 is formed by a detent contour 28, whilst the associated counter-detent element 27 is formed by a detent hook 29. The respective detent hook 29 is in engagement here with the respective detent contour 28 in a form-fitting manner, wherein the respective detent hook 29 engages behind the associated detent contour 28 contrary to the introduction direction 19, so that the charge-air cooler 12 is fixed in the housing 13 contrary to the introduction direction 19, i.e. in a withdrawal direction, in particular through direct physical contact.

In FIG. 2 and in FIG. 4 the detent contour 28 can be formed by a circumferential flange projecting transversely to the introduction direction. Likewise, the outer region 20 of the charge-air cooler 12 can have several flange sections projecting transversely to the introduction direction 19, which respectively form a detent contour 28. Expediently, the housing 13 has several detent hooks 29, which are arranged distributed along the introduction opening 18.

In the embodiments shown in FIGS. 3 and 5, the respective detent element 26 is formed by a detent hook 30, whilst the respective counter-detent element 27 is formed by a detent contour 31. Here, also, the respective detent hook 30 is in engagement with the associated detent contour 31. Expediently, the respective detent hook 30 also engages here over the associated detent contour 31 on a side facing away from the introduction direction 19, whereby in the oppositely oriented withdrawal direction an undercut forms with a form-fitting securing of the respective detent hook 30 on the associated detent contour 31. In the examples of FIGS. 3 and 5, the respective detent hook 30 is designed so as to be yoke-shaped, so that it can also be designated as a detent yoke. In addition, the associated detent contour 31 is formed on a section of the housing 13 which is hook-shaped in profile, so that the detent contour 31 can also be basically designated here as detent hook 31.

As can be seen in addition from FIGS. 2 to 5, the outer end region 20 can have at least one circumferential contact region 32. Matching this, the housing 13 has at least one abutment region 33 running around the introduction opening 18.

In the examples of FIGS. 2 and 3, on introducing of the charge-air cooler 12 into the housing 13, the contact region 32 comes to abut directly against the abutment region 33, when the provided final position between charge-air cooler 12 and housing 13 is reached. In this end position, the locking within the locking arrangement 25 then also takes place.

In contrast thereto, FIGS. 4 and 5 show examples in which the end position between housing 13 and charge-air cooler 12 is reached with the locking within the locking arrangement 25, without the charge-air cooler 12 coming here into direct contact with the housing 13 in the introduction direction 19. As can be seen, a distance or respectively a gap 36 is formed there in the introduction direction between at least one such contact region 32 and the associated abutment region 33.

According to FIG. 2 to 5, expediently at least one seal 34 can be arranged in the contact region 32 or respectively in the abutment region 33, which seal runs around the introduction opening 18, whereby between charge-air cooler 12 and housing 13 in the region of the introduction opening 18 a sufficient airtightness is able to be realized for the avoidance of leakages. The respective seal 34 can be inserted here into a seal groove 35 which is circumferential with respect to the introduction opening 18, which facilitates a defined positioning of the seal 34. With regard to the arrangement of such seal grooves 35, FIGS. 2 and 4 on the one hand, and FIGS. 3 and 5 on the other hand, respectively show several example embodiments. Thus, FIGS. 2 and 4 show a first arrangement on the left and a second arrangement on the right, which are able to be realized only alternatively. FIGS. 3 and 5, on the other hand, show a first arrangement above and a second arrangement below, which are able to be realized alternatively and cumulatively. Accordingly, this seal groove 35 can be constructed according to FIGS. 2 and 4 on the left and according to FIGS. 3 and 5 above in the abutment region 33. According to FIGS. 2 and 4 on the right, the seal groove 35 can also be provided in the contact region 32. FIGS. 3 and 5 below show respectively a variant, in which two seal grooves 35 are provided, namely both in the contact region 32 and also in the abutment region 33, which are aligned to one another parallel to the introduction direction 19.

As already explained above, the variants of FIGS. 4 and 5 differ from the embodiments of FIGS. 2 and 3 only in that a gap 36 is formed in the introduction direction 19 between at least one such contact region 32 and the associated abutment region 33. In the example of FIG. 4, only one pair of contact region 32 and abutment region 33 is provided, so that also only one gap 36 is provided. This gap 36 is bridged here by the respective seal 34, which is associated with this pair. The seal 34 consists of an elastic sealing material, so that it enables an elastic support of the charge-air cooler 12 on the housing 13. In the example of FIG. 4, the charge-air cooler 12 is supported elastically on the housing 13 via this seal 34 only in the introduction direction 19.

In the embodiment shown in FIG. 5, on the other hand, two such pairs of contact region 32 and abutment region 33 are provided, namely a first pair 37 of contact region 32 and abutment region 33 arranged further above in FIG. 5, and a second pair 38 of contact region 32 and abutment region 33 shown further below in FIG. 5. The two pairs 37, 38 of contact region 32 and abutment region 33 are spaced apart from one another here, parallel to the introduction direction 19. In addition, in this case, such a seal 34 is respectively associated with each pair 37, 38 of contact region 32 and abutment region 33, namely a first seal 34 associated with the first pair 37 and a second seal 34 associated with the second pair 38. Consequently, in this example, the charge-air cooler 12 is supported elastically on the housing 13 via the first seal 34 in the introduction direction 19 and via the second seal 34 contrary to the introduction direction 19, i.e. in the withdrawal direction.

1. An air supply system for supplying fresh air to at least one combustion chambers of an internal combustion engine, comprising:
a housing including a fresh air path extending therethrough and a lateral introduction opening,
a charge-air cooler insertable into the housing through the introduction opening along an introduction direction, wherein the charge-air cooler is arranged in the housing and the fresh air path extends through the charge-air cooler,
wherein the charge-air cooler includes an outer end region closing the introduction opening, and
wherein the outer end region of the charge-air cooler is secured to the housing.

2. The air supply system according to claim 1, wherein the charge-air cooler includes a detent element and the housing includes a counter-detent elements disposed complementary to the detent element, wherein the detent element cooperates with the counter-detent element.

3. The air supply system according to claim 2, wherein the detent element is formed integrally on the charge-air cooler.

4. The air supply system according to claim 2, wherein the counter-detent element is formed integrally on the housing.

5. The air supply system according to claim 2, wherein the detent element includes a detent contour and the counter-detent element includes a detent hook, and wherein the detent hook engages the detent contour.

6. The air supply system according to claim 2, wherein the detent element includes a detent hook and the counter-detent element includes a detent contour, and wherein the detent hook engages the detent contour.

7. The air supply system according to claim 1, wherein the outer end region of the charge-air cooler includes at least one circumferential contact region, the at least one contact region disposed opposite an abutment region along the introduction opening, wherein the abutment region extends around the introduction opening.

8. The air supply system according to claim 7, wherein the at least one contact region engages directly against the abutment region.

9. The air supply system according to claim 1, further comprising at least one seal arranged between the housing and the outer end region, the at least one seal extending at least partially around the introduction opening.

10. The air supply system according to claim 7, wherein a gap is arranged along the introduction direction between the at least one contact region and the abutment region, and a seal is arranged in the gap.

11. The air supply system according to claim 10, wherein the charge-air cooler is supported elastically on the housing via the seal in the introduction direction.

12. The air supply system according to claim 10, wherein the seal is a first seal of a plurality of seals, and wherein the charge-air cooler is supported elastically on the housing via the first seal in the introduction direction and via a second seal contrary to the introduction direction.

13. The air supply system according to claim 12, wherein the first seal is arranged in a first gap between a first pair of a contact region and an abutment region, and the second seal is arranged in a second gap between a second pair of a contact region and an abutment region spaced apart from the first pair parallel to the introduction direction.

14. The air supply system according to claim 7, wherein the seal is arranged in a seal groove, wherein the seal groove extends circumferentially with respect to the introduction opening and is disposed in at least one of the at least one contact region and the abutment region.

15. The air supply system according to claim 7, further comprising at least one seal arranged between the housing and the outer end region, the at least one seal extending at least partially around the introduction opening.

16. The air supply system according to claim 3, wherein the detent element includes a detent contour and the counter-detent element includes a detent hook, and wherein the detent hook engages the detent contour.

17. The air supply system according to claim 16, wherein the counter-detent element is integral with the housing.

18. The air supply system according to claim 4, wherein the detent element includes a detent hook and the counter-detent element includes a detent contour, and wherein the detent hook engages the detent contour.

19. The air supply system according to claim 8, further comprising at least one seal arranged between the housing and the outer end region, the at least one seal extending at least partially around the introduction opening.

20. An air supply system for supplying fresh air to at least one combustion chamber of an internal combustion engine, comprising:
a housing including a fresh air path extending therethrough and a lateral introduction opening, the housing further including an abutment region extending around the introduction opening;
a charge-air cooler insertable into the housing through the introduction opening along an introduction direction, wherein the charge-air cooler is arranged in the housing and the fresh air path extends through the charge-air cooler;
a detent element disposed on the charge-air cooler and a counter-detent element disposed on the housing configured to engage the detent element;
wherein the charge-air cooler includes an outer end region closing the introduction opening, the outer end region of the charge-air cooler secured to the housing; and
wherein the outer end region of the charge-air cooler includes a circumferential contact region, the contact region disposed opposite the abutment region along the introduction opening and configured to engage the abutment region.
